(19) United States
(12) Patent Application Publication
(10) Pub. No.: US 2017/0075120 A1
(43) Pub. Date: Mar. 16, 2017

(54) See-Through Near-to-Eye Viewing Optical System

(71) Applicant: Syndiant Inc., Dallas, TX (US)

(72) Inventors: Chun Chiu Daniel Wong, Dallas, TX (US); Po Wing Cheng, Dallas, TX (US)

(21) Appl. No.: 14/953,487

(22) Filed: Nov. 30, 2015

(30) Foreign Application Priority Data
Sep. 11, 2015 (TW) 104130129

(51) Int. Cl. G02B 27/01; G06T 19/00; G02B 1/04; H04R 1/10; G02B 27/28; G02B 27/22

(52) U.S. Cl. CPC G02B 27/0172; G02B 27/283; G02B 27/2214; G02B 1/04; H04R 1/1041; G02B 27/0176; G06T 19/006; G02B 2027/0116; G02B 2027/0138; G02B 2027/014; H04R 2420/01; G02B 2027/0154; G02B 2027/0156

(57) ABSTRACT

A see-through near-to-eye viewing optical system, which can be used in a head-mounted augmented reality display system, is provided. The see-through near-to-eye viewing optical system of the present invention comprises an LED illumination system for generating a light and a pre-polarizer for concentrating said light onto a PBS. Then an LCOS panel receives and reflects said light towards a post-polarizer after generating an image. The light travels from the post-polarizer and passes through an eyepiece for magnifying the image, and continues towards a 50/50 beam splitter. Afterwards the beam splitter transmits said light and another light from the outside field of view to user's eyes simultaneously and thus, the user can see what is shown on the glass screen while still being able to see through it.

This application claims priority to Taiwan Patent Application No. 104130129 filed on Sep. 11, 2015.

### CROSS-REFERENCES TO RELATED APPLICATIONS

Not applicable.

### BACKGROUND OF THE INVENTION

Field of the Invention

The present invention relates to a see-through near-to-eye viewing optical system, and more particularly, to a vertical see-through near-to-eye viewing optical system that employs a beam splitter to provide an image and that can be used in a head-mounted augmented reality display system.

Descriptions of the Related Art

The see-through viewing optical system is a kind of device that allows a user to view both an external image and a projection image simultaneously to achieve the effect of superimposing the real image and the virtual image on each other without masking the field of view. Some conventional see-through viewing optical systems use liquid crystal displays (LCDs) or organic light emitting diodes (OLEDs) as display elements. However, the LCD displays have poor color saturation and poor picture quality, and the OLEDs have a short service life and a high cost and the manufacturing process thereof is so complex that they cannot be produced in mass. There are also other conventional near-to-eye viewing optical systems that, in order to improve the image quality, are designed to be too complex with additionally increased weight and volume.

Further, the conventional see-through near-to-eye viewing optical systems are not used with other sound or light producing elements to provide more effects. Consequently, it is impossible for the user to use the conventional see-through near-to-eye viewing optical systems with sound and images synchronously so as to receive in real time and merge visual and auditory senses and immediately output integrated information currently desired by the user. Consequently, a lot of opportunities of applying the integrated information to the daily life to improvement the living quality or the entertainment quality have been lost. Besides, the conventional see-through near-to-eye viewing optical systems fail to take practical usage conditions into full consideration, so many discomforts and inconveniences in use due to non-conformance to the ergonomics are caused; and they cannot keep up with the worldwide trend of CO₂ emission reduction and energy saving, so unnecessary additional energy consumption is caused to increase the economic burden of the user. Accordingly, there is a need to provide a see-through near-to-eye viewing optical system that can effectively improve the viewing effect and the willingness to use for the user.

### SUMMARY OF THE INVENTION

To achieve the aforesaid objective, the present invention provides a see-through near-to-eye viewing optical system, in which one or more light emitting diode (LED) illumination systems are used to generate a light, the light is concentrated by one or more pre-polarizers to a polarization beam splitter (PBS), and is then received by a Liquid Crystal on Silicon (LCOS) panel so that an image is projected by the LCOS panel through a post-polarizer and an eyepiece, and then the image together with the outside field of view are outputted via a beam splitter to the user's eyes. Thereby, a see-through effect is provided.

A part of the LCOS panel that is used as the display component may be LCOS of the color sequential type or the color filter type, which has the advantage of a small volume, a high resolution, a high contrast, quick response, a low cost and a simple manufacturing process. Furthermore, the beam splitter is used in the see-through near-to-eye viewing optical system of the present invention, and the beam splitter may be made of a plastic material to reduce the weight thereof, to effectively ease the user's burden in use and make an improvement on the fragile nature to increase the durability, and to save the production cost. The beam splitter may also be positioned to include an angle of 45° with the eyepiece to provide a desired viewing image, and the angular position of the beam splitter may also be adjusted by the user to obtain a better image field of view so that, in combination with an external image that is captured, a high-definition (HD) see-through viewing effect can be provided to the user. Additionally, because the pre-polarizer, the PBS and the post-polarizer are disposed in the present invention, interfering light rays can be effectively filtered out so that, in conjunction with the use of the LCOS panel, a better imaging quality can be obtained with a simple optical system. The LED illumination system may be a plurality of red, green and blue LEDs, or may be a white LED. Also, the optical system of the present invention may be of a vertical design to effectively reduce the masked area in the field of view of the user so that a large-area image can be viewed.

Another objective of the present invention is to provide a see-through near-to-eye viewing optical system, which is used with a complementary metal-oxide-semiconductor (CMOS) image sensor (“image sensor” for short hereinbelow) and a drive system board to provide an image outputted to the user's eyes to form a see-through head-mounted augmented reality display system. Specifically, an external image is captured by two image sensors and transmitted to the drive system board to be further processed by the drive system board into a new image, and then the new image is outputted to two see-through near-to-eye viewing optical systems (“optical system” for short) of the present invention. The numbers of the image sensors, the drive system board and the optical system are not limited to what described above.

The see-through near-to-eye viewing optical system of the present invention may be used further with a sound receiver, earphones and a frame so that the user can not only view the image outputted, but also listen to the sound simultaneously with, or before or after viewing the image. Specifically, simultaneously with, or before or after viewing the image, an external sound is recorded by two earphone receivers and is then transmitted to a drive system board for output to the two earphones. Additionally, the frame is mounted on the user' head to support the optical system, the image sensor, the earphones and the sound receivers. The numbers of the sound receivers, the earphones and the frame are not limited to what described above.

The detailed technology and preferred embodiments implemented for the subject invention are described in the following paragraphs accompanying the appended drawings for people skilled in this field to well appreciate the features of the claimed invention.

Both the summary described above and the detailed description below are exemplary, and are provided to further illustrate the scope of the claims of the present invention. Other objectives and advantages of the present invention will be described with reference to the following description and the attached drawings.

### BRIEF DESCRIPTION OF THE DRAWINGS

FIG. 1 is a schematic view of a first embodiment according to the present invention;

FIG. 2 is a schematic view of a second embodiment according to the present invention;

FIG. 3A is a front view of a third embodiment according to the present invention; and

FIG. 3B is a rear view of the third embodiment according to the present invention.

### DESCRIPTION OF THE PREFERRED EMBODIMENT

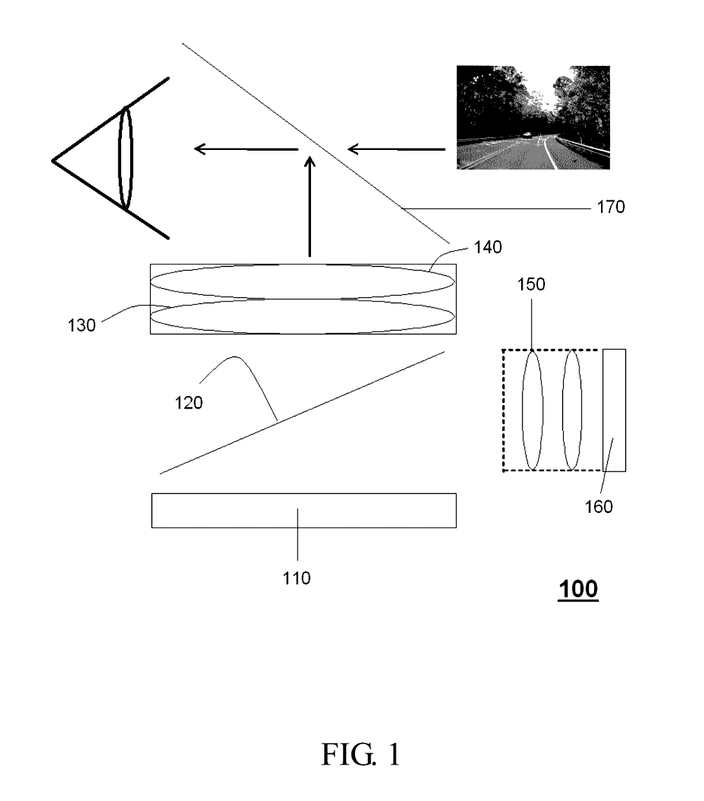

FIG. 1 is a schematic view of a first embodiment of the present invention, which illustrates a front appearance of a see-through near-to-eye viewing optical system 100 of the color filter type. In the embodiment shown therein, the see-through near-to-eye viewing optical system 100 comprises an LCOS panel 110, a PBS 120, a post-polarizer 130, an eyepiece 140, a pre-polarizer 150, a white LED illumination system 160 and a beam splitter 170. The LCOS panel 110 comprises a color filter (not shown). When a light is generated by the white LED illumination system 160, the light is concentrated by the pre-polarizer 150 to the PBS 120 and is then reflected by the PBS 120 to the color filter of the LCOS panel 110 where the white light is split into a red light, a green light and a blue light. Then the LCOS panel 110 receives an image from the drive system board (not shown) and projects the image to the post-polarizer 130 and the eyepiece 140 so that the image is magnified by the eyepiece 140 and outputted via the beam splitter 170 to the user's eyes. Meanwhile, the beam splitter 170 also presents the outside field of view to the user's eyes so that the image displayed on the LCOS panel 110 and the external field of view can be seen by the user at the same time to provide a see-through effect.

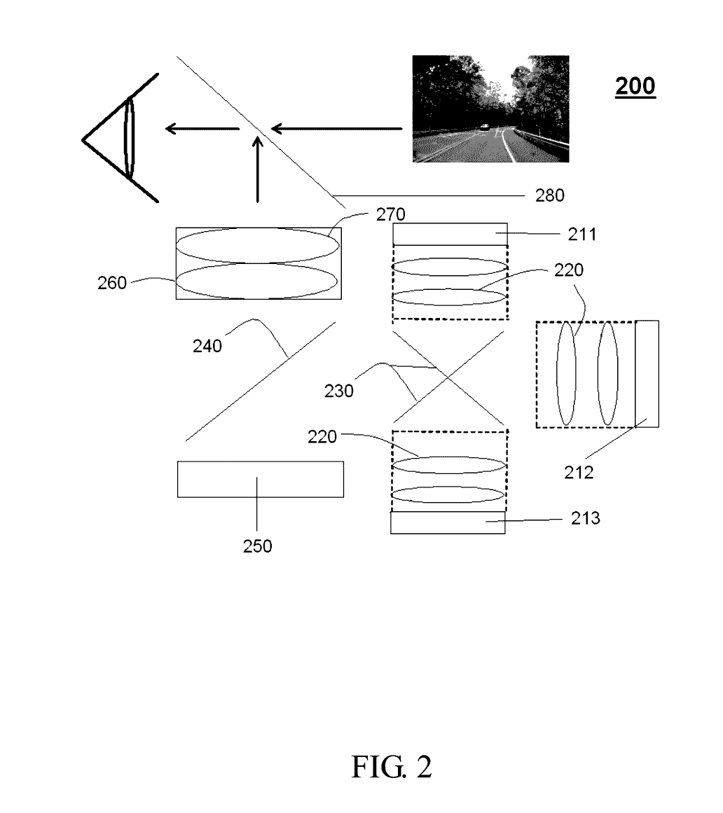

The present invention further provides a see-through near-to-eye viewing optical system 200 of the color sequential type in a second embodiment, a schematic view of which is shown in FIG. 2. The optical system 200 comprises an LCOS panel 250, a PBS 240, a plurality of pre-polarizers 220, a post-polarizer 260, a diachronic mirror 230, an eyepiece 270, a blue LED illumination system 211, a green LED illumination system 212 and a red LED illumination system 213. The blue LED illumination system 211, the green LED illumination system 212 and the red LED illumination system 213 each output a light to a respective pre-polarizer 220. The light is concentrated by the respective pre-polarizer 220 to the dichroic mirror 230 and reflected by the dichroic mirror 230 to the PBS 240, and is then reflected by the PBS 240 to the LCOS panel 250. The LCOS panel 250 receives the image from the drive system board (not shown) and projects the image to the post-polarizer 260 and the eyepiece 270 so that the image is outputted via the beam splitter 280 to the user's eyes. Meanwhile, the beam splitter 280 also presents the outside field of view to the user's eyes so that the image displayed on the LCOS panel 250 and the outside field of view can be seen by the user at the same time to provide a see-through effect. Because no color filter is used in the see-through near-to-eye viewing optical system 200 of the color sequential type, the light will not be absorbed by the color filter to cause degradation in the color saturation and the light utilization efficiency. Instead, the blue LED illumination system, the green LED illumination system and the red LED illumination system are used instead of the color filter to provide a light of a high color saturation level. Thus, a significant improvement on the disadvantage that the see-through near-to-eye viewing optical system 100 of the color filter type degrades the light utilization efficiency can be made.

Further, the beam splitters 170, 280 used in the present invention may be made of a plastic material to reduce the weight of the see-through near-to-eye viewing optical component, effectively ease the user's burden in use and make an improvement on the fragile nature to increase the durability, and save the production cost. The beam splitters 170, 280 used in the present invention may be positioned to include an angle of 45° with the eyepieces 140, 270 respectively to provide a desired viewing image, and the angular position of the beam splitters may also be adjusted by the user to obtain a better image field of view so that, in combination with an external image that is captured, a high-definition (HD) see-through viewing effect can be provided to the user. Additionally, because the pre-polarizers 150, 220, the PBSs 120, 240 and the post-polarizers 130, 260 are disposed in the present invention, interfering light rays can be effectively filtered out so that, in conjunction with the use of the LCOS panels 110, 250 respectively, a better imaging quality can be obtained with a simple optical system.

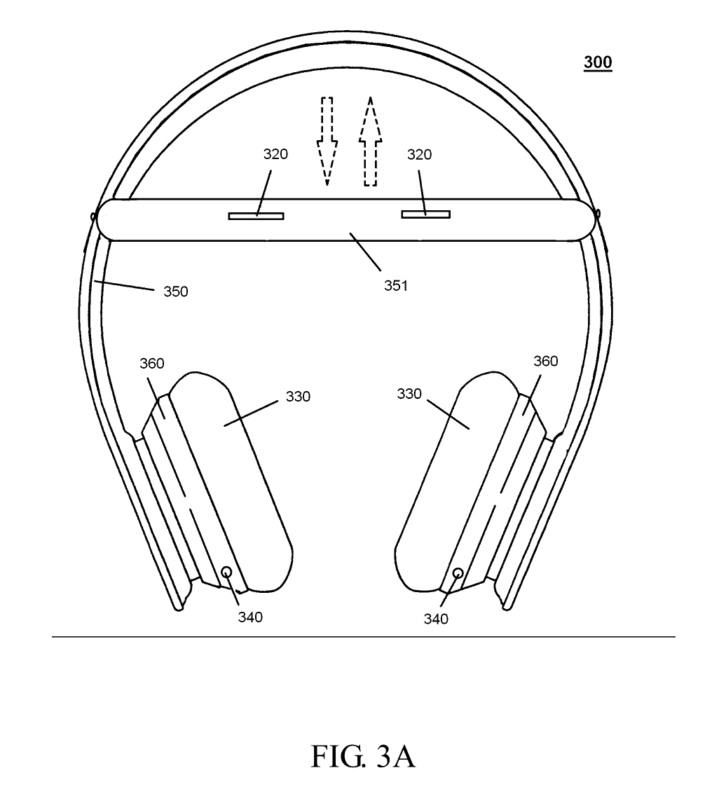

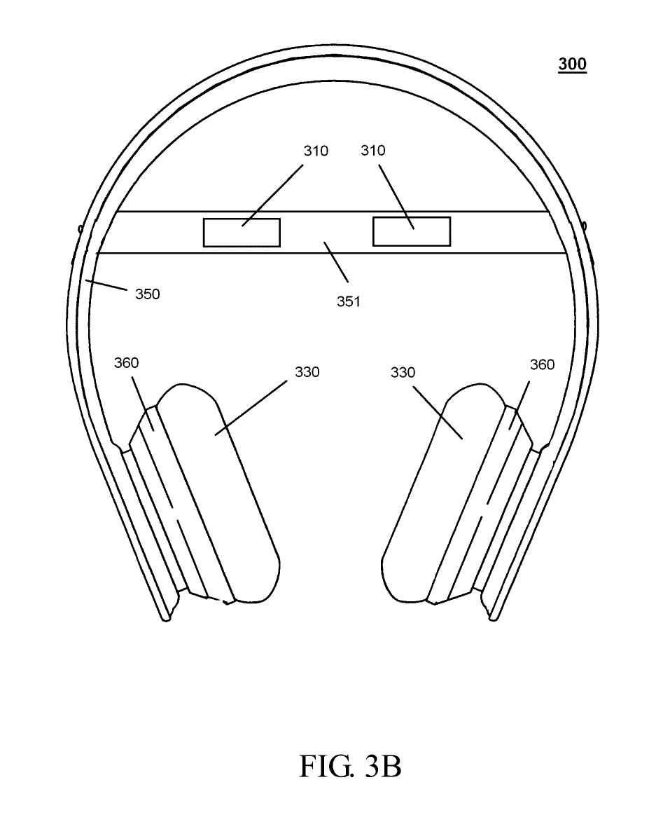

In a third embodiment of the present invention, a see-through near-to-eye viewing optical system 310 is used, together with image sensors 320 and a drive system board 360, in a see-through head-mounted augmented reality display system 200. FIG. 3A is a front view of this embodiment, and FIG. 3B is a rear view of this embodiment. In this embodiment, an external image is captured by two image sensors 320 and transmitted to the drive system board 360, and then the drive system board 360 processes the external image into a single or a multiple image for output to two optical systems 310. The numbers of the image sensors 320, the drive system board 360 and the optical system 310 are not limited to what described above. Further, the single image includes the external image, an internal image downloaded or stored by the drive system board 360, and an integrated image obtained by integrating the external image and the internal image. The multiple image includes Picture by Picture (PBP) images displayed respectively at a left side and a right side, Picture in Picture (PIP) images or Picture out Picture (POP) images.

Referring next to FIG. 3A and FIG. 3B, the see-through near-to-eye viewing optical system 310 of the present invention may further be used in combination with an audio output device so that the user can not only see the image outputted, but also listen to a sound simultaneously with, before or after viewing the image. The audio output process is accomplished as follows: simultaneously with, or before or after displaying of the image by the optical system 310, an external sound is recorded by the two sound receivers 340 into the drive system board 360, and the external sound is processed by the drive system board into another sound for output to the two earphones 330. The numbers of the sound receiver 340, the earphones 330 and the drive system board 360 are not limited to what described above.

In this embodiment, besides that the user can manually switch the earphones to output the external sound recorded by the sound receivers 340, the internal sound downloaded or stored by the drive system board 360, or a mixture of the both, the external sound and the internal sound can also be played by the earphones 330 separately or in mixture according to a signal from the drive system board 360. In other words, the drive system board 360 can automatically switch the earphones 330 to output the sound according to the volume, the direction or the frequency of the external sound received by the sound receiver 340. For example, initially only the internal sound is outputted by the earphones 330, and then when an external sound, e.g., a sound from a person, a sound from an animal, a sound of firecrackers, or a footstep sound, of a specific frequency is detected by the sound receivers 340 or when the external sound reaches a certain volume level, the drive system board 360 can automatically switch the output mode of the earphones according to the factory settings or the user settings so that the sound output is changed from only the internal sound into only the external sound, or still both the internal sound and the external sound are outputted but at slightly adjusted volume levels.

Besides, this embodiment of the present invention further comprises a function of producing stereo audio & video contents. Depending on respective locations, the image sensors 320 can capture external images from different viewing angles and then the external images are processed by the drive system board 360 so that a single or a multiple image is displayed by each of the optical systems 310, and then by virtue of the parallax, a 3D image effect can be perceived by the user. Briefly speaking, the optical system 310 has a function of displaying the original image of picture file in a 3D manner. Likewise, depending on respective locations, the sound receivers 340 can retrieve the external sound from different angles and then the external sound is processed by the drive system board 360 to output high-quality multi-channel stereo sound effect. In combination with the aforesaid function of automatically switching the audio source, this embodiment can make an improvement on the problem with the prior art that the user cannot keep track of the surrounding environment changes. Moreover, the drive system board 360 may even be further provided with the function of a multimedia player or the WiFi function.

Also in this embodiment, the present invention has a frame 350 mounted on the user's head to support the image sensors 320, the optical system 310, the earphones 330 and the sound receivers 340. FIG. 3A and FIG. 3B show that the drive system board 360 is located inside the frame 350, but the drive system board 360 may also be directly mounted outside the frame 350 (this is not shown) and signals are transmitted therebetween in a wired or wireless way.

Additionally, the frame 350 further comprises a foldable frame 351 that is movable upwards and downwards so that the optical system 310 and the image sensor 320 are selectively disposed on the foldable frame 351. The foldable frame 351 is also detachable from the frame 350. This design can ease the discomfort such as the visual fatigue caused during use of the see-through near-to-eye viewing optical system, solve the problem of accommodating the optical system after use, make an improvement on the shortcoming of the prior art that the field of view is masked, and even provide a power saving effect. Specifically, referring to FIG. 3, when masking of the field of view is not desired or when the user feels tired, the user may pull the foldable frame 351 in an upward direction along the dashed arrow. Then, according to the factory settings or the user settings, the screen of the optical system 310 will be automatically turned off or enter into a hibernation state to save the power consumption. If the user wants to use the present invention again later, he or she may pull the foldable frame 351 in a downward direction along the dashed arrow to turn on the screen or to release the hibernation state. Additionally, if the user only wants to receive the sound from the drive board system via the earphones 330, he or she may detach the foldable frame 351 straightforwardly.

As will be appreciated by those skilled in the art, the present invention is not limited to the detailed descriptions of the embodiments disclosed above, but may also be embodied in other specific forms without departing from the spirits of the present invention. The embodiments are provided only for purpose of illustration but not for limitation, and the present invention shall be governed by the claims but not by the aforesaid descriptions. All variations made within the spirits of the claims and equivalents thereof shall all be covered within the scope of the present invention.

What is claimed is:

1. A see-through near-to-eye viewing optical system, comprising:
a light emitting diode (LED) illumination system for generating a light;
a polarizing beam splitter (PBS);
a pre-polarizer for concentrating the light to the PBS;
a post-polarizer;
an eyepiece;
a Liquid Crystal on Silicon (LCOS) panel for projecting an image to the post-polarizer and further to the eyepiece after receiving the light from the PBS, wherein the LCOS panel is an LCOS of the color sequential type or of the color filter type; and
a beam splitter for transmitting the image that passes through the eyepiece and an outside field of view to a user.

2. The see-through near-to-eye viewing optical system of claim 1, wherein the LED illumination system is a plurality of red, green and blue LEDs, or is white LEDs.

3. The see-through near-to-eye viewing optical system of claim 1, wherein the beam splitter is located at a position that includes an angle of 45° with the eyepiece, and the angular position is adapted to be adjusted by the user to obtain an optimal field of view.

4. The see-through near-to-eye viewing optical system of claim 1, wherein the beam splitter is of a plastic material.

5. A see-through head-mounted augmented reality display system, comprising:
at least one sound receiver for recording an external sound;
one or more complementary metal-oxide-semiconductor (CMOS) image sensors for capturing an external image respectively;
at least one drive system board for storing or downloading multimedia data to generate an internal sound and an internal image, receiving the external sound from the sound receiver and the external image from the image sensor, and outputting a sound and an image;
two earphones for outputting the sound inputted from the drive system board respectively, wherein the sound emitted by the earphones may be the external sound received by the sound receiver, the internal sound from the drive system board, or a mixture of the both;
one or more see-through near-to-eye viewing optical components each comprising: an LED illumination system for generating a light; a PBS; a pre-polarizer for concentrating the light to the PBS; a post-polarizer; an eyepiece; an LCOS panel of the color sequential type or of the color filter type for projecting an image to the post-polarizer and further to the eyepiece after receiving the light from the PBS; and a beam splitter for transmitting the image that passes through the eyepiece and an outside field of view to a user; and
a head-mounted frame mounted on the head of the user, being adapted to support the see-through near-to-eye viewing optical component, the CMOS image sensors, the earphones and the sound receiver.

6. The see-through head-mounted augmented reality display system of claim 5, wherein the beam splitter is of a plastic material.

7. The see-through head-mounted augmented reality display system of claim 5, wherein the drive system board comprises functions of a multimedia player, WiFi, or three-dimensional (3D) displaying of an original image or picture file.

8. The see-through head-mounted augmented reality display system of claim 5, wherein the user is allowed to switch the earphones to output the internal sound, the external sound, or the mixture of the both.

9. The see-through head-mounted augmented reality display system of claim 5, wherein the drive system board automatically switches the earphones to output the internal sound, the external sound, or the mixture of the both according to a volume, a direction or a frequency of the external sound.

10. The see-through head-mounted augmented reality display system of claim 5, wherein the drive system board is adapted to output a single or a multiple image.

11. The see-through head-mounted augmented reality display system of claim 5, wherein the frame comprises a foldable frame that is freely movable upwards and downwards relative to the user's eyes.

12. The see-through head-mounted augmented reality display system of claim 5, wherein the see-through near-to-eye viewing optical component and the image sensor are disposed on the foldable frame.

13. The see-through head-mounted augmented reality display system of claim 5, wherein when the foldable frame is pulled upwards, the see-through near-to-eye viewing optical component is turned off or the see-through head-mounted augmented reality display system enters into a hibernation state; and when the foldable frame is pulled downwards, the see-through near-to-eye viewing optical component is turned on or the hibernation state of the see-through head-mounted augmented reality display system is released.

14. The see-through head-mounted augmented reality display system of claim 5, wherein the foldable frame is detachable.
